(19) United States
(12) Patent Application Publication
(10) Pub. No.: US 2020/0013359 A1
(43) Pub. Date: Jan. 9, 2020

(54) DISPLAY APPARATUS AND SWITCH-OFF DRIVE METHOD THEREFOR

(71) Applicants: HKC Corporation Limited, Shenzhen City, Guangdong (CN); Chongqing HKC Optoelectronics Technology Co., Ltd., Chongqing (CN)

(72) Inventor: Wei FU, Chongqing (CN)

(21) Appl. No.: 16/329,144

(22) PCT Filed: Oct. 31, 2018
(86) PCT No.: PCT/CN2018/112919

§ 371 Date: Feb. 27, 2019

(30) Foreign Application Priority Data
Jan. 9, 2018 (CN) 201810018594.7

(51) Int. Cl. G09G 3/36; G02F 1/1362

(52) U.S. Cl. CPC G09G 3/3655; G09G 2330/027; G02F 1/136286

(57) ABSTRACT

This application provides a display apparatus and a switch-off drive method therefor. The display apparatus includes: a display panel, including: at least one scanning line; at least one data line, crossed with the scanning line; at least one active switch, connected to the scanning line and the data line; a common electrode, disposed on the display panel and connected to the active switch, where the common electrode has a co-electrode voltage; and a control component, including one or more control switches, where a first end of the control switch is coupled to the common electrode, a second end of the control switch is coupled to a discharge module, and a control end of the control switch is coupled to a switching voltage, where a status of the control switch is adjusted by using a voltage difference between the switching voltage and the co-electrode voltage.

### BACKGROUND

### Technical Field

This application relates to the display field, and in particular, to a display apparatus and a switch-off drive method therefor.

### Related Art

The liquid crystal display (LCD) has been widely used in recent years. With the improvement of the driving technology, the LCD has the advantages of low power consumption, low voltage driving, and the like, and at present, has been widely applied to camcorders, notebook computers, desktop display apparatuses, and various projection devices.

In addition, an LCD usually includes a gate driver circuit, a source driver circuit, and a pixel array. The pixel array includes a plurality of pixel circuits. Each pixel circuit is switched on or off according to a scanning signal provided by the gate driver circuit, and a corresponding image is presented based on a data signal provided by the source driver circuit.

Due to the limitation of the liquid crystal charging and discharging speed, some residual charges may remain on a liquid crystal panel during switch-off. Consequently, human eyes may see ghost images of the switch-off. A common practice is to generate a control signal during the switch-off, so that a gate driver simultaneously switches on active switches of all channels, and it is expected that charges are released as soon as possible. However, at this time, because an output of a data driver is not determined, the discharging effect will vary depending on image display data. Therefore, this method cannot ensure that the residual charges will be completely eliminated. Therefore, with respect to how to resolve the technical failure problem when the gate driver discharges the display panel, an apparatus that is for eliminating switch-off ghost images, that has low manufacturing costs, and that is easy to process and a method therefor are provided.

### SUMMARY

To resolve the foregoing technical problem, an objective of this application is to provide a display apparatus and a switch-off drive method therefor. By adding a control switch into a display apparatus, a co-electrode voltage can rapidly drop to a 0 potential after switch-off, thereby eliminating the possibility of switch-off ghost images, and improving the product quality.

The objective of this application is achieved and the technical problem of this application is resolved by using the following technical solution. A display apparatus provided according to this application comprises: a display panel, comprising: at least one scanning line; at least one data line, crossed with the scanning line; at least one active switch, connected to the scanning line and the data line; a common electrode, disposed on the display panel and connected to the active switch, where the common electrode has a co-electrode voltage; and a control component, comprising one or more control switches, where a first end of the control switch is coupled to the common electrode, a second end of the control switch is coupled to a discharge module, and a control end of the control switch is coupled to a switching voltage, where a status of the control switch is adjusted by using a voltage difference between the switching voltage and the co-electrode voltage.

The objective of this application may be further achieved and the technical problem thereof may be further resolved by using the following technical measures.

In an embodiment of this application, the control switch is a hole-type field effect transistor.

In an embodiment of this application, when the switching voltage is a first potential, the first potential is greater than or equal to the co-electrode voltage; and when the switching voltage is a second potential, the second potential is a 0 potential.

In an embodiment of this application, when the switching voltage is the first potential, the first end and the second end of the control switch are disconnected.

In an embodiment of this application, when the switching voltage is the second potential, the first end and the second end of the control switch are conducted.

In an embodiment of this application, the common electrode is grounded by using the discharge module.

In an embodiment of this application, the discharge module may be a plurality of discharge resistors connected in series or in parallel.

In an embodiment of this application, the display apparatus further comprises: a plurality of voltage stabilization capacitors, where one end of the voltage stabilization capacitor is connected to the common electrode, and an other end of the voltage stabilization capacitor is grounded.

Another objective of this application is to provide a switch-off drive method for a display apparatus, comprising: adjusting a status of a control switch by using a voltage difference between a switching voltage and a co-electrode voltage; connecting a common electrode, an active switch, and the control switch by using a data line and a scanning line; when the switching voltage is a first potential greater than the co-electrode voltage, disconnecting a first end and a second end of the control switch; when the switching voltage is a second potential that is a 0 potential, conducting the first end and the second end of the control switch, conducting a first end and a second end of the active switch, and connecting the common electrode to a discharge module; and grounding the common electrode by using the discharge module, where the co-electrode voltage drops to a 0 potential.

In an embodiment of this application, the control switch is a hole-type field effect transistor, a control end of the control switch is coupled to the switching voltage, the first end of the control switch is coupled to the common electrode, and the second end of the control switch is coupled to the discharge module.

In an embodiment of this application, the discharge module may be a plurality of discharge resistors connected in series or in parallel.

Still another objective of this application is to provide a display apparatus, comprising: a display panel, comprising: at least one scanning line; at least one data line, crossed with the scanning line; at least one active switch, connected to the scanning line and the data line; a common electrode, disposed on the display panel and connected to the active switch, where the common electrode has a co-electrode voltage; and a control component, comprising one or more control switches, where a first end of the control switch is coupled to the common electrode, a second end of the control switch is coupled to a discharge module, a control end of the control switch is coupled to a switching voltage, and the control switch is a hole-type field effect transistor, where a status between the first end and the second end of the control switch is adjusted by using a voltage difference between the switching voltage and the co-electrode voltage. When the switching voltage is a first potential, the first end and the second end of the control switch are disconnected, the control end and the second end of the control switch are conducted, and the switching voltage is conducted to the discharge module. When the switching voltage is a second potential, the second potential is a 0 potential, the first end and the second end of the control switch are conducted, the common electrode is grounded by using the discharge module, and the co-electrode voltage drops to a 0 potential.

According to this application, a control switch is added into a display apparatus, so that a co-electrode voltage rapidly drops to a 0 potential after switch-off, thereby eliminating the possibility of switch-off ghost images, and improving the product quality.

### BRIEF DESCRIPTION OF THE DRAWINGS

FIG. 1 is a schematic diagram of an exemplary display panel;

FIG. 2 is a schematic diagram of an exemplary pixel circuit;

FIG. 3 is a schematic diagram of another exemplary pixel circuit;

FIG. 4 is a schematic diagram of a display apparatus according to an embodiment of this application;

FIG. 5 is a schematic diagram of a switch-off drive circuit according to an embodiment of this application;

FIG. 6 is a schematic diagram of a switch-off drive circuit according to another embodiment of this application;

FIG. 7 is a schematic diagram of waveforms of a switch-off co-electrode voltage according to an embodiment of this application; and

FIG. 8 is a flowchart of driving a display apparatus according to an embodiment of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, in this specification, “on” means that a component is located above or below a target component, and does not mean that a component needs to be located on the top based on a gravity direction.

To further describe the technical means adopted in this application to achieve the predetermined inventive objective and effects thereof, specific implementations, structures, features, and effects of a display apparatus and a switch-off drive method therefor provided according to this application are described below in detail with reference to the drawings and preferred embodiments.

A display panel of this application may, for example, include a thin film transistor (TFT) substrate, a color filter (CF) substrate, and a liquid crystal layer formed between the two substrates.

In an embodiment, the display panel of this application may be a curved-surface display panel.

In an embodiment, a TFT and a CF of this application may be formed on a same substrate.

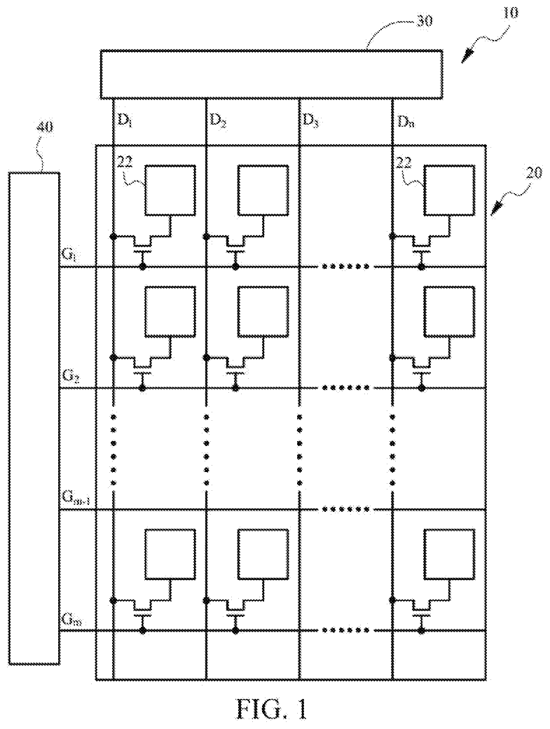

FIG. 1 is a schematic diagram of an exemplary display panel. Referring to FIG. 1, a display panel 10 includes a display module 20 including a plurality of pixels 22 arranged into a two-dimensional array. These pixels are controlled and driven by at least one data line D1, D2, . . . , or Dn, and at least one scanning line G1, G2, . . . , or Gm. A data signal of each data line is provided by a data driver 30 and a gate signal of each scanning line is provided by a gate driver 40.

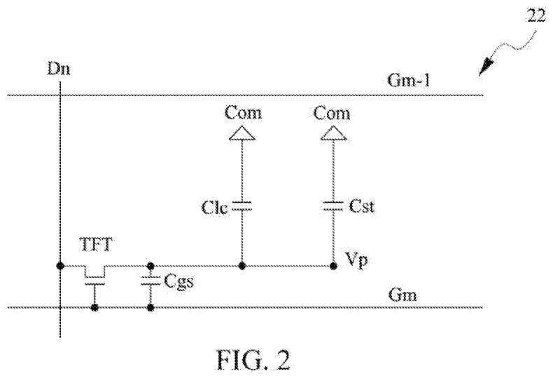

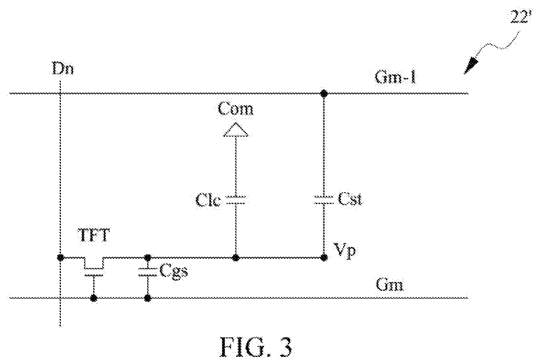

FIG. 2 is a schematic diagram of an exemplary pixel circuit, and FIG. 3 is a schematic diagram of another exemplary pixel circuit. Referring to FIG. 2 and FIG. 3, each pixel 22 or 22′ includes: a data line Dn and scanning lines (Gm-1, Gm), where n and m are positive numbers; and a plurality of capacitors, for example, a liquid crystal capacitor Clc that is formed by a liquid crystal layer capacitor located between upper and lower electrode layers and that is related to the liquid crystal layer capacitor, a storage capacitor Cst that maintains a voltage at a pixel voltage Vp after a scanning line signal passes, and a parasitic capacitor Cgs related to a gate end and a source end of a switching element (active switch, TFT). A total capacitance of pixels of a display panel may vary depending on the design and processing quality of the panel. As shown in FIG. 2, the liquid crystal capacitor Clc and the storage capacitor Cst are both connected to a common electrode Com. As shown in FIG. 3, the liquid crystal capacitor Clc is connected to the common electrode Com, and the storage capacitor Cst is connected to a scanning line.

Due to the limitation of the liquid crystal charging and discharging speed, some residual charges may remain on the panel during switch-off. Consequently, human eyes see ghost images of the switch-off. Referring to FIG. 1 to FIG. 3, a control signal is generated during the switch-off, so that the gate driver simultaneously switches on active switches of all channels, and charges are released as soon as possible. However, at this time, due to the effect of signals such as timing signals, an output of the data driver is not determined. Therefore, the discharging effect will vary depending on image display data, and there is no guarantee that the residual charges will be completely eliminated.

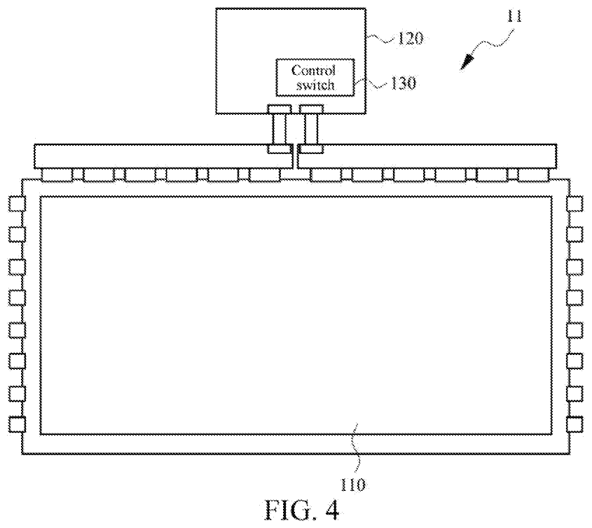

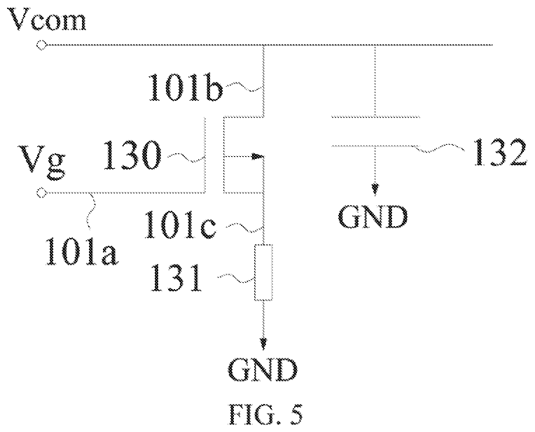

FIG. 4 is a schematic diagram of a display apparatus according to an embodiment of this application and FIG. 5 is a schematic diagram of a switch-off drive circuit according to an embodiment of this application. Referring to FIG. 4 and FIG. 5, in an embodiment of this application, a display apparatus 11 includes: a display panel 110, including: at least one scanning line (not shown); at least one data line (not shown), crossed with the scanning line; at least one active switch (not shown), connected to the scanning line and the data line; a common electrode (not shown), disposed on the display panel 110 and connected to the active switch, where the common electrode has a co-electrode voltage Vcom; and a control component 120, including one or more control switches 130, where a first end 101b of the control switch 130 is coupled to the common electrode, a second end 101c of the control switch is coupled to a discharge module 131, which, for example, may be a discharge resistor 131, and a control end 101a of the control switch is coupled to a switching voltage Vg, where a status of the control switch 130 is adjusted by using a voltage difference between the switching voltage Vg and the co-electrode voltage Vcom.

In an embodiment of this application, the control switch may be a P-type field effect transistor, namely, a hole-type field effect transistor.

In an embodiment of this application, when the switching voltage Vg is a first potential, the first potential is greater than or equal to the co-electrode voltage Vcom; and when the switching voltage Vg is a second potential, the second potential is a 0 potential. The co-electrode voltage is approximately 7 V. Accordingly, the switching voltage Vg may be, for example, a gamma voltage, or a VAA voltage.

In an embodiment of this application, when the switching voltage Vg is the first potential, because Vg is greater than Vcom, the first end 101b and the second end 101c of the control switch 130 are disconnected.

In an embodiment of this application, when the switching voltage Vg is the second potential, because Vg is less than Vcom, the first end 101b and the second end 101c of the control switch 130 are conducted.

In an embodiment of this application, the common electrode is grounded GND by using the discharge resistor 131. The discharge resistor 131 may be, for example, designed as a resistor of several ohms or 0 ohm.

In an embodiment of this application, the display apparatus 11 further includes: a plurality of voltage stabilization capacitors 132, where one end of the voltage stabilization capacitor 132 is connected to the common electrode, and an other end of the voltage stabilization capacitor is grounded GND.

In an embodiment of this application, only one control switch 130 is exemplified in FIG. 5, but the number of the control switches 130 is not limited thereto, and two or more control switches 130 may be connected.

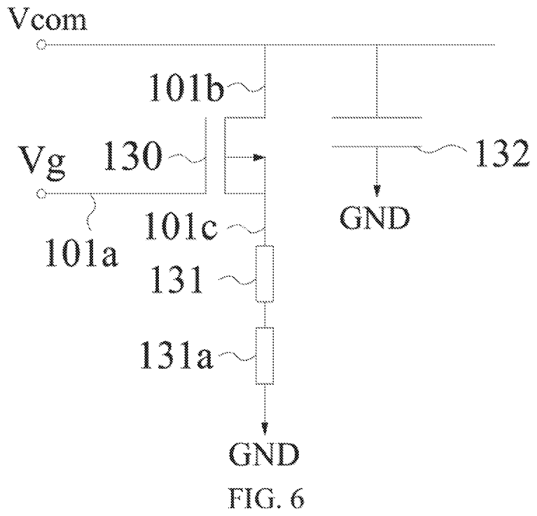

FIG. 6 is a schematic diagram of a switch-off drive circuit according to another embodiment of this application. Referring to FIG. 4 and FIG. 6, in some embodiments, the discharge module may be a plurality of discharge resistors connected in series or in parallel. Two discharge resistors (131, 131a) connected in series are exemplified in FIG. 6, but the number and the connection manner of the discharge resistors are not limited thereto.

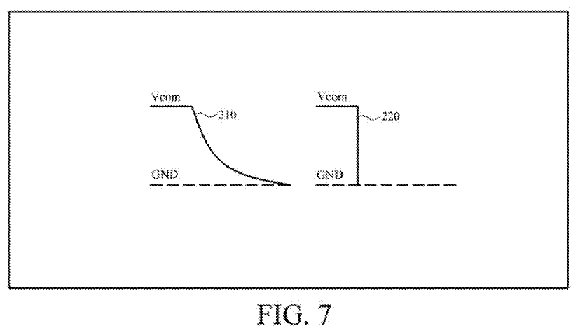

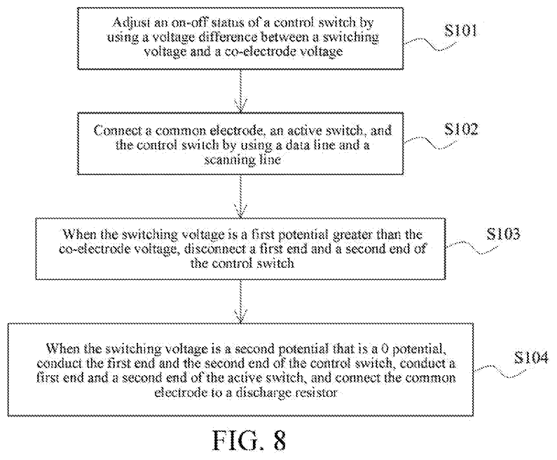

FIG. 7 is a schematic diagram of waveforms of a switch-off co-electrode voltage according to an embodiment of this application; and FIG. 8 is a flowchart of driving a display apparatus according to an embodiment of this application. Referring to FIG. 4 to FIG. 8, a switch-off drive method for a display apparatus includes:

Step S101: Adjust an on-off status of a control switch 130 by using a voltage difference between a switching voltage Vg and a co-electrode voltage Vcom.

Step S102: Connect a common electrode, an active switch, and the control switch 130 by using a data line and a scanning line.

Step S103: When the switching voltage Vg is a first potential greater than the co-electrode voltage Vcom, disconnect a first end 101b and a second end 101c of the control switch 130.

Step S104: When the switching voltage Vg is a second potential that is a 0 potential, conduct the first end 101b and the second end 101c of the control switch 130, conduct a first end and a second end of the active switch, and connect the common electrode to a discharge resistor 131.

In an embodiment of this application, the common electrode Vcom is grounded by using the discharge module 131, which, for example, may be discharge resistors (131, 131a), and then the co-electrode voltage Vcom rapidly drops to a 0 potential.

In an embodiment of this application, the control switch 130 is a P-type field effect transistor, a control end 101a of the control switch 130 is coupled to the switching voltage Vg, the first end 101b of the control switch is coupled to the common electrode Vcom, and the second end 101c of the control switch is coupled to the discharge resistor 131.

Referring to FIG. 6, in an embodiment of this application, a waveform 210 is a switch-off voltage waveform when a control switch 130 is not added. After switch-off, it takes a relatively long period of time (compared with time of switch-off ghost images) for a co-electrode voltage Vcom to drop to a 0 potential. Consequently, a display apparatus has a phenomenon of switch-off ghost images, and experience is affected. A waveform 220 is a switch-off voltage waveform after a control switch 130 is added. It can be seen from the waveform 220 that, after the control switch is added, a co-electrode voltage Vcom can drop to a 0 potential within extremely short time (compared with the waveform 210), and accordingly, the phenomenon of switch-off ghost images is eliminated, thereby improving the experience effect.

In some embodiments, the display apparatus 11 includes: a control component (not shown), and further includes the display panel 110, for example, a quantum dots light-emitting diode (QLED) panel, an organic light-emitting diode (OLED) panel, or an LCD panel. However, the display panel 110 is not limited thereto, and may also be a plasma display panel, or the like.

According to this application, a control switch 130 is added into a display apparatus 11, so that a co-electrode voltage rapidly drops to a 0 potential after switch-off, thereby eliminating the phenomenon of switch-off ghost images, and improving the product quality and the experience effect.

The wordings such as “in some embodiments” and “in various embodiments” are repeatedly used. They usually do not refer to a same embodiment; but they may refer to a same embodiment. Words, such as “comprise”, “have”, and “include” are synonyms, unless other meanings are indicated in the context.

The foregoing descriptions are merely specific embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A display apparatus, comprising:
a display panel, comprising:
at least one scanning line;
at least one data line, crossed with the scanning line;
at least one active switch, connected to the scanning line and the data line;
a common electrode, disposed on the display panel and connected to the active switch, wherein the common electrode has a co-electrode voltage; and
a control component, comprising one or more control switches, wherein a first end of the control switch is coupled to the common electrode, a second end of the control switch is coupled to a discharge module, and a control end of the control switch is coupled to a switching voltage, wherein
a status of the control switch is adjusted by using a voltage difference between the switching voltage and the co-electrode voltage.

2. The display apparatus according to claim 1, wherein the control switch is a hole-type field effect transistor.

3. The display apparatus according to claim 1, wherein when the switching voltage is a first potential, the first potential is greater than the co-electrode voltage.

4. The display apparatus according to claim 3, wherein when the switching voltage is a second potential, the second potential is a 0 potential.

5. The display apparatus according to claim 4, wherein when the switching voltage is the first potential, the first end and the second end of the control switch are disconnected.

6. The display apparatus according to claim 4, wherein when the switching voltage is the second potential, the first end and the second end of the control switch are conducted.

7. The display apparatus according to claim 6, wherein the common electrode is grounded by using the discharge module.

8. The display apparatus according to claim 7, wherein the discharge module is a plurality of discharge resistors connected in series.

9. The display apparatus according to claim 7, wherein the discharge module is a plurality of discharge resistors connected in parallel.

10. The display apparatus according to claim 1, further comprising: a plurality of voltage stabilization capacitors, wherein one end of the voltage stabilization capacitor is connected to the common electrode, and an other end of the voltage stabilization capacitor is grounded.

11. A switch-off drive method for a display apparatus, comprising:
adjusting a status of a control switch by using a voltage difference between a switching voltage and a co-electrode voltage;
connecting a common electrode, an active switch, and the control switch by using a data line and a scanning line;
when the switching voltage is a first potential greater than the co-electrode voltage, disconnecting a first end and a second end of the control switch;
when the switching voltage is a second potential that is a 0 potential, conducting the first end and the second end of the control switch, conducting a first end and a second end of the active switch, and connecting the common electrode to a discharge module; and
grounding the common electrode by using the discharge module, wherein the co-electrode voltage drops to a 0 potential.

12. The switch-off drive method for a display apparatus according to claim 11, wherein the control switch is a hole-type field effect transistor.

13. The switch-off drive method for a display apparatus according to claim 12, wherein a control end of the control switch is coupled to the switching voltage, the first end of the control switch is coupled to the common electrode, and the second end of the control switch is coupled to the discharge module.

14. The display apparatus according to claim 13, wherein the discharge module is a plurality of discharge resistors connected in series.

15. The display apparatus according to claim 13, wherein the discharge module is a plurality of discharge resistors connected in parallel.

16. A display apparatus, comprising:
a display panel, comprising:
at least one scanning line;
at least one data line, crossed with the scanning line;
at least one active switch, connected to the scanning line and the data line;
a common electrode, disposed on the display panel and connected to the active switch, wherein the common electrode has a co-electrode voltage; and
a control component, comprising one or more control switches, wherein a first end of the control switch is coupled to the common electrode, a second end of the control switch is coupled to a discharge module, a control end of the control switch is coupled to a switching voltage, and the control switch is a hole-type field effect transistor, wherein
a status between the first end and the second end of the control switch is adjusted by using a voltage difference between the switching voltage and the co-electrode voltage;
when the switching voltage is a first potential, the first end and the second end of the control switch are disconnected, the control end and the second end of the control switch are conducted, and the switching voltage is conducted to the discharge module; and
when the switching voltage is a second potential, the second potential is a 0 potential, the first end and the second end of the control switch are conducted, the common electrode is grounded by using the discharge module, and the co-electrode voltage drops to a 0 potential.
